(19) United States
(12) Patent Application Publication
(10) Pub. No.: US 2009/0266714 A1
(43) Pub. Date: Oct. 29, 2009

(54) Method for Forming Multi-Layer Coating Film

(76) Inventors: Toshio Kaneko, Neyagawa-shi (JP); Satoshi Okamoto, Neyagawa-shi (JP); Masanobu Futsuhara, Tokyo (JP); Makoto Doi, Osaka (JP); Eisaku Okada, Toyota-shi (JP); Takehiro Nito, Toyota-shi (JP)

Correspondence Address: WENDEROTH, LIND & PONACK, L.L.P., 1030 15th Street, N.W.,, Suite 400 East, Washington, DC, 20005-1503, US

(21) Appl. No.: 11/887,587

(22) PCT Filed: Apr. 7, 2006
(86) PCT No.: PCT/JP2006/307879

§ 371 Date: Jan. 15, 2008

(30) Foreign Application Priority Data
Apr. 7, 2005 (JP) 2005-111179

(51) Int. Cl. C09D 5/44; C25D 9/12

(52) U.S. Cl. 205/50; 205/170

(57) ABSTRACT

The present invention is to provide a method for forming a multi-layer coating film, which can combine a pre-treating step conducted for a metal substrate, before electrodeposition coating, and an electrodeposition coating step. The method comprises:
a step of dipping a material to be coated in an aqueous coating composition comprising (A) a rare earth metal compound, (B) a base resin having a cationic group, and (C) a curing agent, wherein a content of the rare earth metal compound (A) in the aqueous coating composition is limited to specific range;
a pre-treating step of applying a voltage of less than 50 V in the aqueous coating composition, wherein the material to be coated is used as a cathode; and
an electrodeposition coating of applying a voltage of 50 to 450 V in the aqueous coating composition, wherein the material to be coated is used as a cathode.

### TECHNICAL FIELD

The present invention relates to a method for forming a multi-layer coating film, a method that is capable of combining a pre-treating (substrate treatment) step in which a metal substrate, especially a non-treated cold rolled steel sheet, is treated before electrodeposition coating, and an electrodeposition coating step, by using one aqueous coating composition.

### BACKGROUND OF INVENTION

Automobile bodies are produced by molding a metal material, such as a cold rolled steel sheet or a zinc-plated steel sheet, coating the metal moldings as a material to be coated, and assembling them. In general, the metal moldings are subjected to corrosion resistant treatment such as chemical treatment with zinc phosphate, before electrodeposition coating, in order to impart adhesion property to electrodeposition coating films.

Electrodeposition coating using a cationic electrodeposition coating composition is widely used mainly for automobile bodies and as primers for parts, because the coating method can give uniform coating films with good corrosion resistance and throwing power. Conventional cationic electrodeposition coating compositions can give sufficient corrosion resistance to a material to be coated by electrodeposition coating, when the material is subjected to pre-treating with zinc phosphate or the like; but it is difficult to ensure corrosion resistance, if the material is not subjected to sufficient pre-treating (chemical treatment, and the like).

Japanese Patent No. 3,168,381 describes a cathodically electrodeposition coating composition which comprises a hydrophilic film-forming resin containing a cationic group and a curing agent, which are dispersed in an aqueous medium containing a neutralizing agent, wherein at least one phosphomolybdate selected from aluminum salts, calcium salts and zinc salts is contained in an amount of 0.1 to 20% by weight, and a cerium compound is contained in an amount of 0.01 to 2.0% by weight in terms of metal, % by weight being based on the solid content of the coating composition. The coating composition improves corrosion resistance to cold rolled steel sheets which are not subjected to surface treatment.

Japanese Patent No. 3,368,399 describes a cathodically electrodeposition coating composition comprising a hydrophilic film-forming resin containing a cationic group and a curing agent, which are dispersed in an aqueous medium containing a neutralizing agent, wherein a copper compound and a cerium compound are totally contained in an amount of 0.01 to 2.0% by weight in terms of metal based-on the solid content of the coating composition, and a metal weight ratio of copper/cerium is 1/20 to 20/1. Similar to the above patent, it is also described that corrosion resistance to cold rolled steel sheets which are not subjected to surface treatment can be improved.

According to the methods using the above-mentioned electrodeposition coating composition, one-stage electrodeposition coating is performed under conditions of an applied voltage of 100 to 450 V. Under such electrodeposition conditions, however, film-formation with cerium or cerium-copper is insufficient. Consequently, according to the methods of improving the corrosion resistance of these inventions, the obtained levels have not reached the level of the adhesion property toward a substrate and corrosion resistance after electrodeposition coating realized by conventional chemical conversion treatments with phosphate.

Currently, a pre-treating step and an electrodeposition coating step require respectively a chemical treatment liquid and a cationic electrodeposition coating composition, and they are performed separately in two steps using different two liquids from each other. The chemical treatment liquid and the cationic electrodeposition coating composition are different from each other in pH range where the components stably dissolve or disperse in the liquid or the composition. As a result, if these liquids are combined, many disadvantages such as unstability of mixed liquid would occur, that is, it would not be easy to combine these two steps. Moreover, in electrodeposition coating, the incorporation of a chemical treatment agent negatively affects coating efficiency, corrosion resistance and appearance of the obtained films, even if its amount is small. From these reason, after pre-treating and before electrodeposition coating, a material to be coated must be washed with water thoroughly, thus resulting in requirement of long and big coating facilities for pre-treating and electrodeposition coating.

### SUMMARY OF THE INVENTION

In view of the above-mentioned circumstances, the object of the present invention is to provide a method which can surprisingly combine the pre-treating step and the electrodeposition coating step to integrate the two steps by using a specific aqueous coating composition, whereas in conventional methods, the pre-treating and the electrodeposition coating are separately carried out by using a chemical treatment liquid and a cationic electrodeposition coating composition, respectively.

The present invention provides a method for forming a multi-layer coating film comprising a step of dipping a material to be coated in an aqueous coating composition comprising (A) a rare earth metal compound, (B) a base resin having a cationic group, and (C) a curing agent, wherein a content of the rare earth metal compound (A) in the aqueous coating composition is 0.05 to 10% by weight in terms of rare earth metal, based on the solid content of the coating composition;

a pre-treating step of applying a voltage of less than 50 V in the aqueous coating composition, wherein the material to be coated is used as a cathode; and

an electrodeposition coating of applying a voltage of 50 to 450 V in the aqueous coating composition, wherein the material to be coated is used as a cathode, whereby the above-mentioned object can be attained.

The aqueous coating composition preferably further comprises (D) a copper compound or (E) a zinc compound.

In the above-mentioned pre-treating step, an electrolytic reaction product derived from the rare earth metal compound (A) is present in an amount of not less than 5 mg/m².

In the above-mentioned pre-treating step, an electrolytic reaction products derived from the rare earth metal compound (A) and the copper compound (D), or an electrolytic reaction products derived from the rare earth metal compound (A) and the zinc compound (E) is present in an amount of not less than 5 mg/m².

In the above-mentioned pre-treating step, an energizing time is preferably 10 to 300 seconds.

In the above-mentioned electrodeposition coating step, an energizing time is preferably 30 to 300 seconds.

The above-mentioned aqueous coating composition has preferably a pH of 5 to 7, and a conductivity of 1500 to 4000 μS/cm.

The above-mentioned rare earth metal compound (A) is preferably a compound comprising at least one rare earth metal selected from the group consisting of cerium (Ce), yttrium (Y), neodymium (Nd), praseodymium (Pr) and ytterbium (Yb).

The present invention also provide a multi-layer coating film obtained by the method for forming a multi-layer coating film mentioned above.

### TECHNICAL EFFECTS OF THE INVENTION

According to the method for forming a multi-layer coating film of the present invention, a cathode electrolytic treatment step (pre-treating step) and an electrodeposition coating step can be practically divided and continuously carried out by using one aqueous coating composition and applying voltage to it in at least two stages. The method of the present invention can efficiently combine the pre-treating step and the electrodeposition coating. By using such a method, conventional pre-treating such as chemical treatment and coating step comprising electrodeposition coating can considerably be shortened. According to the method of the present invention, multi-layer coating films with adhesion property to a coating film and corrosion resistance (good results are shown in salt spray test, salt water immersion test, wet-and-dry cycle corrosion test, and the like) as excellent as the properties obtained by conventional method of chemical treatment followed by electrodeposition, can be obtained.

According to the method of the present invention, the pre-treating process, which has been practiced before the electrodeposition coating (especially, chemical treatment process), can be eliminated or be significantly shortened (i.e. shortening of treating time or shortening of rinsing time) even if it has to be conducted, whereby technical effects of the present invention are significant. Also, although a low-voltage energizing step is added for the pre-treating process in the electrodeposition process, what is only necessitated for this process is changing applied voltage from the pre-treating process to the electrodeposition process, which can be conducted continuously. This addition of low-voltage energizing step does not give any load on the electrodeposition process.

### DETAILED DESCRIPTION OF THE INVENTION

### Aqueous Coating Composition

The method for forming a multi-layer coating film of the present invention is carried out using an aqueous coating composition which comprises (A) a rare earth metal compound, or a combination of (A) a rare earth metal compound and (D) a copper compound or (E) a zinc compound in an aqueous medium, and (B) a base resin having a cationic group and (C) a curing agent which are dispersed in the aqueous medium. The aqueous coating composition used in the present invention will be described in detail.

The rare earth metal compound (A) contained in the aqueous coating composition used in the present invention is preferably a compound containing at least one rare earth metal selected from the group consisting of cerium (Ce), yttrium (Y), neodymium (Nd), praseodymium (Pr) and ytterbium (Yb). Among them, the particularly preferable rare earth metals are cerium (Ce) and neodymium (Nd). The rare earth metal compound containing the rare earth metal contained in the aqueous coating composition can give pre-treated coating films with excellent adhesion property to a substrate.

As the rare earth metal compound (A), water-soluble compounds and compound poorly soluble in water may be used. Among others, the use of water-soluble compounds having solubility in water of not less than 1 g/dm³ is more preferable, because high corrosion resistance can be obtained by using even a small amount. It is more preferable that nitrate of rare earth metal is used as the rare earth metal compound (A), because the use thereof can give coating films with adhesion resistance as excellent as or more excellent than that of films obtained by using a lead compound.

Preferable examples of the rare earth metal compound (A) are organic acid salts such as cerium formate, yttrium formate, praseodymium formate, ytterbium formate, cerium acetate, yttrium acetate, praseodymium acetate, neodymium acetate, ytterbium acetate, cerium lactate, yttrium lactate, ytterbium lactate, neodymium lactate, praseodymium lactate and ytterbium oxalate; inorganic acid salts and inorganic compounds such as cerium nitrate, yttrium nitrate, neodymium nitrate, samarium nitrate, ytterbium nitrate, praseodymium nitrate, yttrium tungstate, praseodymium molybdate, neodymium amidosulfate, ytterbium amidosulfate, neodymium oxide and praseodymium hydroxide; and the like. Among them, preferred is a compound of neodymium (Nd), praseodymium (Pr) or ytterbium (Yb), which is excellent in electrolytic deposition.

The aqueous coating composition used in the method for forming a multi-layer coating film of the present invention may further comprises, in addition to the rare earth metal compound (A), the copper compound (D) or the zinc compound (E). By further containing the copper compound (D) or the zinc compound (E), a rare earth metal-copper complex compound or a rare earth metal-zinc complex compound, which are poorly soluble in alkali, can be formed as an electrolytic reaction product in the pre-treating step, whereby higher adhesion property of the multi-layer coating film and corrosion resistance after electrodeposition coating can be expressed. For the above purpose, preferred is a combination of rare earth metal compound (A) and zinc compound (E).

The copper compound (D) to be used together with the rare earth metal compound (A) can be water-soluble copper salts, for example, organic monocarboxylic acid salts such as formates, acetates, propionates and lactates; inorganic acid salts such as nitrates, phosphates and sulfates; halides such as chlorides and bromides. Also, copper oxides, copper hydroxides and copper salts, which are capable of producing copper ion in a coating bath, may also be used.

Preferable copper compounds include monocarboxylic acid salts and double salts having a compositional formula: [Cu(OH)₂]ₓ[CuSiO₃]_{y}[CuSO₄]_{z}[H₂O]ₙ wherein weight fraction x, y, z and n show 18 to 80%, 0 to 12%, 20 to 60% and 100−(x+y+z) %, respectively.

The zinc compound (E) to be used together with the rare earth metal compound (A) can be water-soluble zinc salts, for example, an organic monocarboxylic acid salts such as formates, acetates, propionates and lactates; inorganic acid salts such as nitrates, phosphates and sulfates; halides such as chlorides and bromides. Also, zinc oxides, zinc hydroxides and zinc silicates, which are capable of producing zinc ion in a coating bath, may also be used. Preferable zinc compounds include water-soluble salts such as monocarboxylic acid salts, zinc nitrates and zinc sulfates, and the like. Further, complex compounds of zinc oxide capable of producing zinc ion in a coating composition bath, and condensed zinc phosphate, (poly)zinc phosphate and zinc phosphomolybdate may be used. The zinc compounds may generally be used as a pigment.

The rare earth metal compound (A), the copper compound (D) and the zinc compound (E) are preferably all water-soluble or water-dispersible compounds.

When the copper compound (D) or the zinc compound (E) is used together with the rare earth metal compound (A), a weight ratio of the rare earth metal:copper or zinc is preferably 1:20 to 20:1. When the weight ratio of the rare earth metal:copper or zinc exceeds the above-mentioned range, effect for improving adhesion property and corrosion resistance can lower due to formation of a complex compound. It is to be noted that the above-mentioned weight ratio shows a weight ratio of the metals contained in the components, and each metal weight is calculated from the rare earth metal compound (A), the copper compound (D) or zinc compound (E).

The aqueous coating composition used in the present invention contains 0.05 to 10% by weight of the rare earth metal compound (A) in terms of rare earth metal based on the solid content of the coating composition. When the aqueous coating composition further comprises the copper compound (D) or the zinc compound (E), it is preferably contained in a total content of 0.05 to 10% by weight in terms of the metal based on the solid content of the coating composition. When the metal conversion content is less than 0.05% by weight, corrosion resistance based on sufficient adhesion property to a substrate cannot be obtained. On the other hand, when the metal conversion content exceeds 10% by weight, dispersion stability of the aqueous coating composition or smoothness and water resistance of the electrodeposition coating film can lower. The metal conversion content of the rare earth metal compound (A), or of the rare earth metal compound (A) and the copper compound (D), or of the rare earth metal compound (A) and the zinc compound (E) is more preferably 0.08 to 8% by weight, most preferably 0.1 to 5% by weight.

Introduction of the rare earth metal compound (A), the rare earth metal compound (A) and the copper compound (D), or the rare earth metal compound (A) and the zinc compound (E) into the aqueous coating composition is not particularly limited, and it may be conducted in the same manner as usual methods for dispersing a pigment. For example, the rare earth metal compound (A), and, as occasion demands, the copper compound (D) or the zinc compound (E) may be previously dispersed in a resin for dispersion to prepare a dispersion paste, and this dispersion paste may be admixed with an aqueous coating composition. Alternatively, when a water-soluble rare earth metal compound, a water-soluble copper compound or a water-soluble zinc compound is used as the rare earth metal compound (A), the copper compound (D) or the zinc compound (E), it may be added as it is to a prepared resin emulsion for coating composition. As the resin for dispersing a pigment, resins usually used in cationic electrodeposition coating compositions (for example, epoxy sulfonium salt resins, epoxy quaternary ammonium salt resins, epoxy tertiary ammonium salt resins, acrylic quaternary ammonium salt resins, and the like) may be used.

The base resin (B) having a cationic group in the aqueous coating composition used in the present invention is a cation-modified epoxy resin obtained by modifying an oxirane ring of a resin backbone with an organic amine compound.

In general, cation-modified epoxy resins are prepared by reacting oxirane ring of a starting material resin molecule with a amine such as primary amine, secondary amine or tertiary amine to cause ring-opening. Typical examples of the starting material resin are polyphenol polyglycidyl ether type epoxy resins which are reaction products of a polycyclic phenol compound such as bisphenol A, bisphenol F, bisphenol S, phenol novolac or cresol novolac with epichlorohydrin.

As other examples of the starting material resin, oxazolidone ring-containing epoxy resins having the following formula, described in Japanese Patent Laid-open Publication No. 5-306327 may be used for the cation-modified epoxy resin.

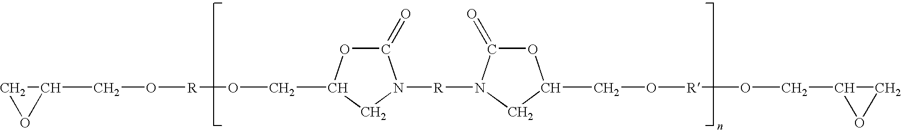

wherein R is a residue in which glycidyloxy group is removed from a diglycidyl epoxy compound, R″ is a residue in which isocyanate group is removed from a diisocyanate compound, and n is a positive integer, from which coating films with high heat resistance and corrosion resistance can be obtained.

The above-mentioned starting material resin may be extended with a difunctional polyester polyol, polyether polyol, bisphenols or dibasic carboxylic acid, before the ring-opening reaction of the oxirane ring with amines.

Similarly, the resin wherein some epoxy rings may be added by a monohydroxyl compound such as 2-ethyl hexanol, nonyl phenol, ethyleneglycol mono-2-ethylhexyl ether, propyleneglycol mono-2-ethylhexyl ether, before the ring-opening reaction of the epoxy ring with amines, in order to control molecular weight or amine equivalent and to improve heat flow property, and the like.

Examples of the amines, which can be used for introducing an amine group after ring-opening the oxirane ring, include butyl amine, octyl amine, diethyl amine, dibutyl amine, methyl butyl amine, monoethanol amine, diethanol amine, N-methylethanol amine, and a primary, secondary or tertiary amic acid salt such as triethyl amic acid salt or N,N-dimethylethanol amino acid salt. The amine may also be a secondary amine having a ketimine-blocked primary amino group, such as aminoethylethanolamine methylisobutylketimine, diethylenetriamine methylisobutyldiketimine and the like. The above mentioned epoxy resin can be modified with the ketimine-blocked amine and prepared into an aqueous coating composition to regenerate a primary amino group. In order to ring-open all of the oxirane rings, the amines are required to use in at least equivalent to the oxirane rings.

The number average molecular weight of the cation-modified epoxy resin is within the range of 1,000 to 5,000, preferably 1,500 to 3,000. When the number average molecular weight is less than 1,000, the physical properties of the cured coating film such as solvent resistance and corrosion resistance can be inferior. On the other hand, when it exceeds 5,000, not only the viscosity control of the resin solution but also the handling property of the obtained resin, such as emulsification or dispersal, can be difficult. Moreover, the flow property at heating and curing is inferior due to high viscosity, thus resulting in possibility of poor appearance of the coating film.

The cation-modified epoxy resin is preferably designed so as to have a hydroxyl value of 50 to 250 (KOH-converted mg/g resin solid content). When the hydroxyl value is less than 50, insufficient curing of the coating film can occur, whereas when it exceeds 250, excessive hydroxyl groups remain in the coating film after curing, thus resulting in lowering of water resistance.

The cation-modified epoxy resin is preferably designed so as to have an amine value of 40 to 150 (KOH-converted mg/g resin solid content). When the amine value is less than 40, insufficient emulsification or dispersant in the aqueous medium can occur when neutralization is conducted with an acid, whereas it exceeds 150, excessive amino groups in the coating film after curing, thus resulting in lowering of water resistance. It is preferred that the amine value is within the range of 50 to 120.

It is also preferred that the amine value based on primary amino group in the resins is within the range of 15 to 50, because the rare earth metal compound is selectively and predominantly deposited on the material to be coated during cathodic electrolysis (pre-treating step).

When the epoxy resin has a plural of oxazolidone ling in its molecular, the oxazolidone-containing epoxy resin (a) may be reacted with a monohydric active hydrogen-containing compound (b) and a dihydric active hydrogen-containing compound (c) in such conditions that an equivalent of active hydrogen of the active hydrogen-containing compounds (b) and (c) is less than that of epoxy group in the epoxy resin (a), followed by reacting with gallic acid (d) and secondary monoamine compound (e) so as to the epoxy groups remaining in the reacted epoxy resin (a) are all ring-opened, thus obtaining an aqueous coating composition. The aqueous coating composition thus obtained has excellent corrosion resistance and heat resistance, because the epoxy resin contains oxazolidone rings, the gallic acid shows chelate function and the rare earth metal compound reduces under alkali atmosphere.

On the stage where the oxirane ring of the epoxy resin is modified with amine, the epoxy resin wherein a part or all of the rings are modified with thiol group may be used together with the amine-modified epoxy resin. This embodiment is more preferable, because chelating function caused by the thiol group in the resin toward the metal component in the electrolytic reaction product deposited in the pre-treating step, enhances the adhesion property to a electrodeposition resin coating film and, therefore, it can be expected to improve the corrosion resistance.

The curing agent (C) used in the present invention may be anyone, so long as it can cure a resin component when it is heated. Among them, preferred are blocked polyisocyanates, which have suitably been used as a curing agent for electrodeposition resins.

Examples of polyisocyanates for the blocked polyisocyanate include aliphatic diisocyanates such as hexamethylene diisocyanate (including trimer), tetramethylene diisocyanate, trimethylhexamethylene diisocyanate; alicyclic polyisocyanates such as isophorone diisocyanate, 4,4′-methylenebis(cyclohexyl isocyanate); aromatic diisocyanates such as 4,4′-diphenylmethane diisocyanate, tolylene diisocyanate, and xylene diisocyanate. The blocked polyisocyanate can be obtained by blocking the isocyanate with an appropriate blocking agent.

Examples of the preferred blocking agent include monohydric alkyl (or aromatic) alcohols such as n-butanol, n-hexyl alcohol, 2-ethyl hexanol, lauryl alcohol, phenolcarbinol, and methylphenyl carbinol; cellosolves such as ethyleneglycol monohexyl ether and ethyleneglycol mono-2-ethylhexyl ether; polyethers with diols at the both ends such as polyethylene glycol, polypropylene glycol, and polytetramethylene ether glycol phenol; polyesters with polyols at the both ends obtained from diols such as ethylene glycol, propylene glycol and 1,4-butanediol, and dicarboxylic acid such as oxalic acid, succinic acid, adipic acid, suberic acid and sebacic acid; phenols such as para-t-butylphenol and cresol; oximes such as dimethyl ketoxime, methyl ethyl ketoxime, methyl isobutyl ketoxime, methyl amyl ketoxime, and cyclohexanone oxime; and lactams such as ε-caprolactam and γ-butyrolactam. The oxime and lactam blocking agents dissociate at low temperatures, and thus they are preferable from the viewpoint of resin curability when the film is baked together with an intermediate coating film in a later step.

Desirably, the blocked polyisocyanates are previously blocked with one or more blocking agents. A blocking ratio is preferably 100% in order to ensure storage stability of coating compositions, if there is no intention of modification with the above-mentioned resin components.

The mixing ratio of the blocked polyisocyanate to the base resin (B) having a cationic group depends on necessary cross-linking degree corresponding to the purpose of cured coating films, and it is preferably within the range of 15 to 40% by weight in terms of solid content in view of coating film properties and compatibility with an intermediate coating. The mixing ratio of less than 15% by weight can lead to insufficient curing of coating films, thus resulting in lowering of film properties such as mechanical strength. Also, there is a possibility that poor appearance occurs, for example, the coating film is attacked by paint thinner upon applying intermediate paint. On the other hand, when it exceeds 40% by weight, curing can proceed too much, thus resulting in poor film properties such as impact resistance. It is to be noted that the blocked polyisocyanate may be used in combination of multiple kinds, for controlling coating film properties, degree of curing and curing time.

The amino group in the base resin (B) having a cationic group is neutralized with an inorganic acid such as hydrochloric acid, nitric acid or hypophosphorous acid, or an organic acid such as formic acid, acetic acid, lactic acid, sufamic acid, acetylglycinic acid in an suitable amount to prepare a cationic emulsion wherein the resin is emulsified or dispersed in water. In general, the emulsion particles containing the curing agent (C) as a core and the base resin (B) having a cationic group as a shell are formed by emulsifying or dispersing.

The average particle size of the emulsion particles is generally from 0.01 to 0.5 μm, preferably from 0.02 to 0.3 μm, more preferably from 0.05 to 0.2 μm. When the average particle size is less than 0.01 μm, an excess neutralizing agent is required for dispersing the resin component in water, and thus the electrodeposition efficiency per a certain electric charge can lower. On the other hand, when it exceeds 0.5 μm, the dispersibility of the particles lowers, and thus the storage stability of the electrodeposion coating composition can unfavorably lower.

In the aqueous coating composition used in the coating method of the present invention, pigments may be added depending on the purpose, though the pigments are not essential components. Provided that the pigment herein does not include the rare earth metal compound (A), the copper compound (D) and the zinc compound (E). Any pigment used for general paints may be used without particular limitations. Examples thereof are coloring pigments such as carbon black, titanium dioxide, and graphite; extender pigment such as kaolin, aluminum silicate (clay), talc, calcium carbonate, and inorganic colloids (silica sol, alumina sol, titanium sol, zirconia sol, and the like); free heavy metal type corrosion resistant pigments such as phosphoric acid pigments (aluminum phosphomolybdate, calcium phosphate, and the like), and molybdate pigments (aluminum phosphomolybdate, and the like).

Furthermore, silane coupling agents such as vinyltriethoxysilane, γ-methacryloxypropyltrimethoxysilane may be used with the pigment. The use of both the inorganic colloid and the silane coupling agent promotes improvement of adhesion property of the coating film toward a substrate, and, as a result, corrosion resistance is preferably improved.

Among them, the particularly important pigments used in the aqueous coating composition in the present invention include titanium dioxide, carbon black, aluminum silicate (clay), silica, and aluminum phosphomolybdate. Titanium dioxide and carbon black have high hiding because they are coloring pigments, and are inexpensive, and therefore they are optimum for use in electrodeposition coating films.

The above-mentioned pigments may be used alone, but two or more pigments are generally used in accordance with the purpose.

The ratio {P/(P+V)} of the weight of the pigment (P) toward the total weight (P+V) of the pigment and the resin solid content (V) contained in the aqueous coating composition (hereinafter referred to as “PWC”) is preferably within the range of 5 to 30% by weight, provided that the pigment (P) herein is defined as one which does not include the rare earth metal compound (A), the copper compound (D) and the zinc compound (E).

When the weight ratio is less than 5% by weight, barrier property of the coating film toward corrosion factors such as water and oxygen remarkably lowers due to an insufficient amount of the pigment, and thus weatherability and corrosion resistance, which endure practical use, cannot be shown. When the composition does not have such a disadvantage, however, a clear or nearly clear aqueous coating composition whose pigment content reaches as near 0 as possible is prepared and it may be used in the present invention.

The use of the content of more than 30% by weight is not good, because the excessive pigment can cause increase of viscosity upon curing, and thus flow property lowers to give poor appearance of coating films.

The resin solid content (V) mentioned above referred to a total solid content of all resins constituting the electrodeposition coating film, including the base resin (B) having a cationic group, which is the main resin in the aqueous coating composition, the curing agent (C), and the pigment dispersion resins.

The aqueous coating composition is adjusted so as to have a the total solid content within the range of 5 to 40% by weight, preferably 10 to 25% by weight. In order to control the total solid content, an aqueous medium (water alone or a mixture of water and a hydrophilic organic solvent) is used.

The aqueous coating composition has preferably a pH of 5 to 7, more preferably 5.5 to 6.5. When the pH is less than 5, the electrodeposition coating efficiency or appearance of coating film can lower. On the other hand, when it exceeds 7, it tends to lower stability of rare earth metal ions and copper ions in the coating composition and the base resin emulsion. When the pH is high, the pH can be decreased by using an inorganic acid such as nitric acid or sulfuric acid, or an organic acid such as formic acid or acetic acid. On the other hand, when the pH is low, the pH can be increased by using an organic base such as amine, or an inorganic base such as ammonium or sodium hydroxide. The pH can be adjusted by using the inorganic acid, organic acid, inorganic base or organic base in a necessary amount. The acid and base to be used are not particularly limited.

The aqueous coating composition used in the present invention has preferably a conductivity of 1,500 to 4,000 μS/cm. When the conductivity is less than 1,500 μS/cm, the technical effects obtained in the pre-treating step can be insufficient, and throwing power of pre-treating films or electrodeposition coating films can be insufficient. On the other hand, when it exceeds 4,000 μS/cm, unfavorably, films obtained in pre-treating or electrodeposition coating films can have poor appearance. The words “pre-treating film” in the instant specification refers to a film obtained by deposing the electrolytic reaction product of the rare earth metal compound (A), or of the rare earth metal compound (A) and the copper compound (D), or of the rare earth metal compound (A) and the zinc compound (E) on a material to be coated.

The conductivity of the aqueous coating composition may be determined by using a commercially available electric conductivity meter. Examples of the electric conductivity meter are, for instance, CM-305 made by TOA Electronics, Ltd., and the like.

Further, the coating composition may contain a small amount of additives. Examples of the additives are ultraviolet absorbers, anti oxidants, surfactants, smoothing agents for film surface, curing catalysts (organic tin compounds such as dibutyltin oxide, dioctyltin dilaurate, dibutyltin dilaurate, dioctyltin dilaurate, dibutyltin diacetate, dibutyltin dibenzoate, and dioctyltin dibenzoate), and the like.

### Method for Forming a Multi-Layer Coating Film

The method for forming a multi-layer coating film of the present invention is performed by dipping a material to be coated in the aqueous coating composition. Further, the method for forming a multi-layer coating film of the present invention includes

a pre-treating step wherein a voltage of less than 50 V is applied in the aqueous coating composition, using a material to be coated as a cathode, and

an electrodeposition coating step wherein a voltage of 50 to 450 V is applied in the aqueous coating composition, using the material to be coated as a cathode.

Examples of the material to be coated include untreated metal materials such as cold rolled steel sheet, high strength steel, high tensile steel, cast iron, zinc and zinc-plated steel, aluminum and aluminum alloy, and the like. Among them, the material capable of getting remarkably excellent corrosion resistance by the method of the present invention is cold rolled steel sheet.

The material to be coated is dipped in the aqueous coating composition prepared as above as a cathode. In the present invention, it has been found that, in the pre-treating step, a voltage of less than 50 V is applied to conduct a cathode electrolysis for a material to be coated, whereby the electrolytic reaction product of the rare earth metal compound (A), or of the rare earth metal compound (A) and the copper compound (D), or of the rare earth metal compound (A) and the zinc compound (E) can remarkably preferentially be deposited.

When the voltage is 50 V or more, the deposition of the base resin (B) having a cationic group and the curing agent (C), which are vehicles for the coating composition, rather than the electrolytic reaction product can be remarkable, which is, unfavorably, contrary to the purpose of pre-treating coating film formulation.

The applied voltage is preferably within the range of 1 to 40 V, more preferably 1 to 20 V, for the electrolytic reaction product of the rare earth metal compound (A), or of the rare earth metal compound (A) and the copper compound (D), or of the rare earth metal compound (A) and the zinc compound (E).

The pre-treating step is preferably conducted in conditions that a temperature of a bath containing the aqueous coating composition is controlled to 15 to 35° C., because performance of the pre-treating step at a temperature similar to usual bath temperatures in the electrodeposition coating step next to the pre-treating step is preferable, in view of the electrodeposition coating step, which is performed next to the pre-treating step.

The energizing time of the pre-treating is generally from 10 to 300 seconds, preferably from 30 to 180 seconds. When the treatment time is too short, coating films are not formed or corrosion resistance can be inferior due to insufficient thickness of the films. When the energizing time is too long, sometimes poor appearance such as burning with no gloss can be shown. Moreover, excessive treatment time leads to remarkably lowering of productivity, which is not preferable.

In the pre-treating, the deposition amount of electrolytic reaction product of the rare earth metal compound (A), or the rare earth metal (A) and the copper compound (D), or the rare earth metal compound (A) and the zinc compound (E) is controlled to not less than 20 mg/m² to form coating films with especially high corrosion resistance. The deposition amount is preferably 10 to 1,000 mg/m², more preferably 20 to 500 mg/m².

When the deposition amount of the electrolytic reaction product is less than 20 mg/m², necessary corrosion resistance cannot be obtained because of poor adhesion property toward a substrate caused by a formed coating film. When the deposition amount exceeds 1,000 mg/m², unfavorably, appearance of the electrodeposition coating films can be poor because of insufficient smoothness of the coating film surface.

The mechanism wherein the electrolytic reaction product is deposited according to the pre-treating step of the present invention can be thought as follows: Chemical species in the bath, such as dissolved oxygen, hydrogen ion, and water, are reduced on the surface of cathode or metal, which is a material to be coated, under the above-mentioned electrolysis conditions in the pre-treating step to generate hydroxide ion (OH⁻). The generated hydroxide ion on the surface of metal to be treated reacts first with the rare earth metal ion around the metal surface to generate hydroxide of the rare earth metal, and the hydroxide is deposited on the metal surface as a coating film. The thus deposited hydroxide film of the rare earth metal, which is the electrolytic reaction product, has remarkably superior adhesion property toward a substrate and electrodeposition coating film. It is believed, although not limited thereto that the hydroxide of rare earth metal deposited on the substrate partially or totally turns to oxide of rare earth metal by dehydration during baking or drying step after electrodeposition step, whereby the electrodeposition coating films show particularly high corrosion resistance.

In addition, by containing the copper compound (D) or the zinc compound (E) in the aqueous coating composition, a rare earth metal-copper complex compound poorly soluble in alkali or a rare earth metal-zinc complex compound poorly soluble in alkali can be deposited as an electrolytic reaction product. The thus obtained complex compound can give higher adhesion property and corrosion resistance to a multi-layer coating film to be obtained.

Moreover, under the conditions of the pre-treating step in the present invention, mainly, the above-mentioned pre-treating film preferentially forms, and formulation of the electrodeposition coating film by deposition of the base resin (B) having a cationic group and the curing agent (C) tends to inhibit, which are very advantageous.

In the electrodeposition coating step in the present invention, by increasing a voltage up to from 50 to 450 V, preferably up to from 100 to 400 V, the base resin (B) having a cationic group, which is a vehicle for the coating composition, the curing agent (C), and the necessary pigments are preferentially deposited. When a voltage of less than 50 V is applied, a deposition amount of the vehicle in the electrodeposition coating composition can be insufficient. On the other hand, when the voltage exceeds 450 V, the vehicle components deposit in an amount more than the proper level, and as a result, the appearance which cannot practically be used, can be obtained.

A bath of the aqueous coating composition has preferably a temperature of 15 to 35° C. The temperature range is suitable for electrodeposition coating, and it is preferable to conduct the pre-treating step and the electrodeposition coating step, these steps being conducted in succession, at the similar temperatures from the viewpoint of operation.

The energizing time is from 30 to 300 seconds, preferably from 30 to 180 seconds. When the treatment time is less than 30 seconds, electrodeposition coating films are not formed or corrosion resistance can be inferior due to insufficient thickness of the films. On the other hand, excessive treatment time leads to remarkably lowering of productivity, which is not preferable.

The thus obtained uncured, multi-layer coating film is cured at 120 to 200° C., preferably at 140 to 180° C., to give a cured, multi-layer coating film. When the temperature exceeds 200° C., the obtained film is too hard and brittle. On the other hand, when it is less than 120° C., unfavorably, curing is insufficient, thus resulting in low film properties such as solvent resistance and film strength.

### EXAMPLES

The present invention will be explained in more detail by means of the following Examples, but the present invention is not limited thereto. In Examples, “parts” and “%” are by weight unless otherwise noted.

### Preparation Example 1

### Preparation of a Base Resin (B) Having a Cationic Group

A reaction vessel equipped with a stirrer, a decanter, a nitrogen-introducing tube, a thermometer and a dropping funnel was fed with a bisphenol A epoxy resin having an epoxy value of 188 (a trade mark “DER-331J” made by The Dow Chemical Company) 2,400 parts, methanol 141 parts, methyl isobutyl ketone 168 parts and dibutyltin dilaurate 0.5 parts, and the mixture was stirred at 40° C. to uniformly dissolve. Then, 320 parts of 2,4-/2,6-tolylene diisocyanate (a mixture with a weight ratio of 80/20) was added dropwise thereto over 30 minutes to rise a temperature to 70° C., to which N,N-dimethylbenzylamine 5 parts was added to rise a system temperature to 120° C. The reaction was continued at 120° C. for 3 hours while methanol was distilled away until the epoxy value reached to 232. After methyl isobutyl ketone 644 parts, bisphenol A 341 parts, and 2-ethylhexanoic acid 413 parts were added thereto, the reaction was continued while the system temperature was kept at 120° C. until the epoxy value reached 840, and the reaction system was cooled to a system temperature of 110° C. Then, a mixture of diethylenetriamine diketimine (a methyl isobutyl ketone solution with a solid content of 73%) 288 parts and N-methylethanolamine 300 parts and di(2-ethylhexyl)amine 314 parts was added, and the reaction was carried out at 120° C. for 1 hour to give a cation-modified epoxy resin. It was then diluted with 194 parts of methyl isobutyl ketone until non-volatile content was 80% by weight, to form a cation-modified epoxyresin varnish with a solid content of 80% by weight. The resin had a number average molecular weight of 1,800, an amine value of 100 (especially amine value based on primary amino group of 20) and a hydroxyl value of 160. Infrared absorption spectrum confirmed that the resin had oxazolidone ring (absorbance wavelength: 1750 cm⁻¹).

### Preparation Example 2

### Preparation of a Curing Agent (C)

A reaction vessel equipped with a stirrer, a nitrogen-introducing tube, a condenser and a thermometer was fed with isophoronediisocyanate 222 parts, which was diluted with methyl isobutyl ketone 56 parts, then butyl tin laurate 0.2 part was added thereto, and a temperature thereof was raised to 50° C. Then, methylethylketoxime 17 parts was added to the mixture so as not to exceed an content temperature of 70° C. The reaction mixture was kept at 70° C. for 1 hour until substantial disappearance of the absorption was confirmed by infrared absorption spectrum. After that, the reaction mixture was diluted with n-butanol 43 parts to give an objective blocked isocyanate curing agent solution (solid content: 70%).

### Preparation Example 3

### Preparation of a Pigment Dispersion Resin

A reaction vessel equipped with a stirrer, a condenser, a nitrogen-introducing tube and a thermometer was fed with a bisphenol A epoxy resin having an epoxy value of 198 (a trade mark “Epon 829” made by Shell Chemicals Ltd.) 710 parts, and bisphenol A 289.6 parts, and the reaction was conducted at 150 to 160° C. for 1 hour under nitrogen atmosphere. After the reaction mixture was cooled to 120° C., a methyl isobutyl ketone solution of tolylene diisocyanate half-blocked with 2-ethylhexanol (solid content: 95%) 406.4 parts was added thereto. The reaction mixture was kept at 110 to 120° C. for 1 hour, then ethyleneglycol mono-n-butyl ether 1584.1 parts was added thereto, and the mixture was cooled to 85 to 95° C. to homogenize it.

Separately from the above-mentioned preparation of the reaction product, a mixture of a methyl isobutyl ketone solution of tolylene diisocyanate half-blocked with 2-ethylhexanol (solid content: 95%) 384 parts and dimethylethanolamine 104.6 parts was stirred in another reaction vessel at 80° C. for 1 hour, then a 75% aqueous lactic acid solution 141.1 parts was fed into the mixture, with which ethyleneglycol mono-n-butyl ether 47.0 parts was mixed, and the mixture was stirred for 30 minutes to prepare a quaternizing agent (solid content: 85%). The quaternizing agent 620.46 parts was added to the reaction product obtained above, and the mixture was kept at 85 to 95° C. until the acid value reached 1 to give a solution (resin solid content: 56%) of a pigment dispersion resin (average molecular weight: 2,200).

### Preparation Example 4

### Preparation of a Pigment Dispersion Paste

A pigment past (solid content: 59%) was prepared by dispersing the following composition containing the pigment dispersion resin obtained in Preparation Example 3 at 40° C. in a sand mill until the particle size reached not more than 5 μm.

| Composition | Part |
|---|---|
| pigment dispersion resin varnish | 53.6 |
| obtained in Preparation Example 3 | |
| titanium dioxide | 54.0 |
| carbon black | 1.0 |
| aluminum phosphomolybdate | 4.0 |
| clay | 11.0 |
| ion-exchanged water | 46.4 |

### Preparation Example 5

### Preparation of Thiol Group-Modified Epoxy Resin

A flask equipped with a stirrer, a condenser, a nitrogen-introducing tube, a thermometer and a dropping funnel was added with an epoxy resin having an epoxy value of 474, which was synthesized from bisphenol A and epichlorohydrin, 947 parts, methyl isobutyl ketone (MIBK) 520 parts and tetrabutylammoniumbromide 6 parts, and the temperature was raised to 80° C. After the contents uniformly dissolved, thiobenzoic acid 281 parts was added dropwise thereto over 30 minutes. During the addition, the temperature was raised due to heat generation, but the temperature was controlled so as not to exceed 90° C. by cooling with water. After the addition was finished, the contents were aged by keeping them at 80° C. for 1 hour to give a thiol-modified epoxy resin having saturated absorption (1690 cm⁻¹) based on thiol ester group, which was measured by infrared spectrum, an epoxy value of not less than 140,000, a number average molecular weight of 1200, and crosslinkability.

### Preparation Example 6

### Preparation of an Aqueous Coating Composition

The base resin obtained in Preparation Example 1, 350 g (solid content) and the curing agent obtained in Preparation Example 2, 150 g (solid content) were mixed, to which ethyleneglycol mono-2-ethylhexyl ether was added in a content of 3% (15 g) based on the solid content.

When the tiol-modified epoxy resin obtained in Preparation Example 5 was mixed, a part of the base resin obtained in Preparation Example 1 was substituted with it in a mixing ratio of resins shown in Table 1, and then an equal amount of ethyleneglycol mono-2-ethylhexyl ether was added as described above.

Then, glacial acetic acid was added thereto so as to be a neutralization ratio of 40.5% to neutralize, to which ion-exchange water was slowly added to dilute it, and methyl isobutyl ketone was removed under reduced pressure to give a solid content of 36%.

To the thus obtained emulsion 2000 g were added the pigment past obtained in Preparation Example 4, 460.0 g, ion-exchange water 2252 g, and dibutyl thin oxide in an amount of 1% by weight based on the resin solid content, and stirred to give an aqueous coating composition having a solid content of 20.0% by weight.

The rare earth metal compound, or the rare earth metal compound and the copper compound or zinc compound were directly added to the aqueous coating composition in case of acetic acid salts and nitric acid salts; or they were added so that in stead of a part of titanium dioxide in the pigment past, an addition amount (% by weight) of metal shown in Table 1 was used in other cases, to prepare aqueous coating compositions.

### Examples and Comparative Examples

In preparation of the aqueous coating composition of Preparation Example 6, rare earth metal compound was contained in an amount of 0.5% by weight in terms of metal, as shown in Tables 1 to 4. The thus obtained aqueous coating composition was poured into a bath, and a cold rolled steel sheet, which was not surface-treated, was dipped therein as a cathode. Next, as shown in Tables 1 and 2, applied voltage was raised in at least two stages to continuously conduct a pre-treating step (applied voltage: 5 V, energizing time 60 seconds) and an electrodeposition coating step (applied voltage: 180 V, energizing time: 150 seconds). In Comparative Examples except Comparative Example 8, the above pre-treating step was eliminated and the cationic electrodeposition step was conducted. In the electrodeposition coating step, coating was conducted to give an electrodeposition coating film with a dry film thickness of 20μ, then, curing was conducted at 170° C. for 20 minutes, and film evaluation was conducted. The results in Examples and Comparative Examples in film test items are shown in Tables 1 to 4.

The procedures of evaluation tests are shown below.

### Salt Spray Test

Salt spray test: With respect to a coated plate on which a cross-cut which reached the substrate was formed with a knife, a salt spray test was conducted in compliance with JIS Z 2371. In a testing time of 840 hours, the following items were evaluated.
Blister evaluation; after the test was finished, a blister state (the number of the blisters) on the whole surface of the plate to be evaluated was evaluated. ◯; a little, Δ; slightly many, x; many
Peeling evaluation; after the test was finished, the plate to be evaluated was washed with water and dried. Peeling with a tape was conducted, and maximum width of the peeled part from the cut part was measured (mm). ◯; less than 3 mm, Δ; from 3 to 6 mm, x; not less than 6 mm

### Salt Water Immersion Test

Salt water immersion test: The coated plate on which a cut which reached the substrate was formed with a knife was subjected to a salt water immersion test in a 5% salt solution at 55° C. for 240 hours. The evaluation was conducted with respect to the following items.
Blister evaluation; after the test was finished, a blister state (the number of the blisters) on the whole surface of the plate to be evaluated was evaluated. ◯; a little, Δ; slightly many, x; many
Peeling evaluation; after the test was finished, the plate to be evaluated was washed with water and dried. Peeling with a tape was conducted, and maximum width of the peeled part from the cut part was measured (mm). ◯; less than 4 mm, Δ; from 4 to 8 mm, x; not less than 8 mm

### Measurement of Conductivity of Coating Composition

The electric conductivity was measured by using an electric conductivity meter (“CM-305” made by TOA Electronics, Ltd.) at 25° C. in a bath containing 200 ml of the cationic electrodeposition coating composition obtained in each of Examples and Comparative Examples.

TABLE 1

| | | Example | | | | |
|---|---|---|---|---|---|---|
| | | 1 | 2 | 3 | 4 | 5 |
| Each | Cerium acetate | 0.5 | | | | |
| composition²⁾ | Cerium nitrate | | 0.5 | | | |
| | Neodymium acetate | | | 0.5 | | |
| | Neodymium | | | | 0.5 | |
| | amidosulfate | | | | | |
| | Yttrium acetate | | | | | 0.5 |
| | Praseodymium nitrate | | | | | |
| | Ytterbium nitrate | | | | | |
| | Copper double salt¹⁾ | | | | | |
| | Zinc acetate | | | | | |
| Resin ratio | | 100/0 | 100/0 | 100/0 | 100/0 | 100/0 |
| Preparation Example 1/Preparation | | | | | | |
| Example 5 | | | | | | |
| The first | Voltage (V) | 5 | 5 | 5 | 5 | 5 |
| step | Energization time | 60 | 60 | 60 | 60 | 60 |
| | (second) | | | | | |
| The second | Voltage (V) | 180 | 180 | 180 | 180 | 180 |
| step | Energization time | 150 | 150 | 150 | 150 | 150 |
| | (second) | | | | | |
| Evaluation | Solt spray test | | | | | |
| | Blister evaluation | ◯ | ◯ | ◯ | ◯ | ◯ |
| | Peeling test | ◯ | ◯ | ◯ | ◯ | ◯ |
| | Salt water immersion test | | | | | |
| | Blister evaluation | ◯ | ◯ | ◯ | ◯ | ◯ |
| | Peeling test | ◯ | ◯ | ◯ | ◯ | ◯ |

| | | | | | |
|---|---|---|---|---|---|
| Amount of electrolytic reaction product | 40 | 38 | 45 | 32 | 35 |
| deposited (mg/m²) | | | | | |
| Conductivity (μS/cm) | 2900 | 3200 | 2800 | 3000 | 2900 |
| pH | 6.0 | 5.9 | 6.0 | 5.9 | 6.0 |

¹⁾Copper double salt: [Cu(OH)2]x[CuSiO3]y[CuSO4]z[H2O]n weight ratio x/y/z = 50/3/35
²⁾The amount of each component is % by weight in terms of metal.

TABLE 2

| | | Example | | | | |
|---|---|---|---|---|---|---|
| | | 6 | 7 | 8 | 9 | 10 |
| Each | Cerium acetate | 0.3 | 0.3 | | | |
| composition²⁾ | Cerium nitrate | | | | | |
| | Neodymium acetate | | | | | |
| | Neodymium | | | | | |
| | amidosulfate | | | | | |
| | Yttrium acetate | | | | | |
| | Praseodymium nitrate | | | 0.5 | | |
| | Ytterbium nitrate | | | | 0.5 | 0.3 |
| | Copper double salt¹⁾ | 0.2 | | | | |
| | Zinc acetate | | 0.2 | | | 0.2 |
| Resin ratio | | 90/10 | 90/10 | 100/0 | 100/0 | 100/0 |
| Preparation Example 1/Preparation | | | | | | |
| Example 5 | | | | | | |
| The first | Voltage (V) | 5 | 5 | 5 | 5 | 5 |
| step | Energization time | 60 | 60 | 60 | 60 | 60 |
| | (second) | | | | | |
| The second | Voltage (V) | 180 | 180 | 180 | 180 | 180 |
| step | Energization time | 150 | 150 | 150 | 150 | 150 |
| | (second) | | | | | |
| Evaluation | Solt spray test | | | | | |
| | Blister evaluation | ◯ | ◯ | ◯ | ◯ | ◯ |
| | Peeling test | ◯ | ◯ | ◯ | ◯ | ◯ |
| | Salt water immersion test | | | | | |
| | Blister evaluation | ◯ | ◯ | ◯ | ◯ | ◯ |
| | Peeling test | ◯ | ◯ | ◯ | ◯ | ◯ |

| | | | | | |
|---|---|---|---|---|---|
| Amount of electrolytic reaction product | 22 | 28 | 45 | 60 | 50 |
| deposited (mg/m²) | | | | | |
| Conductivity (μS/cm) | 2400 | 2600 | 2850 | 2900 | 3000 |
| pH | 6.2 | 6.1 | 6.0 | 5.9 | 6.1 |

¹⁾Copper double salt: [Cu(OH)2]x[CuSiO3]y[CuSO4]z[H2O]n weight ratio x/y/z = 50/3/35
²⁾The amount of each component is % by weight in terms of metal.

TABLE 3

| | | Comparative Example | | | | |
|---|---|---|---|---|---|---|
| | | 1 | 2 | 3 | 4 | 5 |
| Each | Cerium acetate | 0.5 | | | | |
| composition²⁾ | Cerium nitrate | | 0.5 | | | |
| | Neodymium acetate | | | 0.5 | | |
| | Neodymium | | | | 0.5 | |
| | amidosulfate | | | | | |
| | Yttrium acetate | | | | | 0.5 |
| | Praseodymium nitrate | | | | | |
| | Ytterbium nitrate | | | | | |
| | Copper double salt¹⁾ | | | | | |
| | Zinc acetate | | | | | |
| Resin ratio | | 100/0 | 100/0 | 100/0 | 100/0 | 100/0 |
| Preparation Example 1/Preparation | | | | | | |
| Example 5 | | | | | | |
| The first | Voltage (V) | — | — | — | — | — |
| step | Energization time | — | — | — | — | — |
| | (second) | | | | | |
| The second | Voltage (V) | 180 | 180 | 180 | 180 | 180 |
| step | Energization time | 150 | 150 | 150 | 150 | 150 |
| | (second) | | | | | |
| Evaluation | Solt spray test | | | | | |
| | Blister evaluation | X | X | X | X | X |
| | Peeling test | X | X | X | X | X |
| | Salt water immersion test | | | | | |
| | Blister evaluation | X | X | X | X | X |
| | Peeling test | X | X | X | X | X |

| | | | | | |
|---|---|---|---|---|---|
| Amount of electrolytic reaction product | 3 | 4 | 4 | 4 | 3 |
| deposited (mg/m²) | | | | | |
| Conductivity (μS/cm) | 2900 | 3200 | 2800 | 3000 | 2900 |
| pH | 6.0 | 5.9 | 6.0 | 5.9 | 6.0 |

¹⁾Copper double salt: [Cu(OH)2]x[CuSiO3]y[CuSO4]z[H2O]n weight ratio x/y/z = 50/3/35
²⁾The amount of each component is % by weight in terms of metal.

TABLE 4

| | | Comparative Example | | | | |
|---|---|---|---|---|---|---|
| | | 6 | 7 | 8 | 9 | 10 |
| Each | Cerium acetate | 0.3 | 0.3 | | | |
| composition²⁾ | Cerium nitrate | | | | | |
| | Neodymium acetate | | | | | |
| | Neodymium | | | 0.04 | | |
| | amidosulfate | | | | | |
| | Yttrium acetate | | | | | |
| | Praseodymium nitrate | | | | | |
| | Ytterbium nitrate | | | | 0.5 | 0.3 |
| | Copper double salt¹⁾ | 0.2 | | | 0.5 | |
| | Zinc acetate | | 0.2 | | | 0.2 |
| Resin ratio | | 90/0 | 90/0 | 100/0 | 100/0 | 100/0 |
| Preparation Example 1/Preparation | | | | | | |
| Example 5 | | | | | | |
| The first | Voltage (V) | — | — | 5 | — | — |
| step | Energization time | — | — | 60 | — | — |
| | (second) | | | | | |
| The second | Voltage (V) | 180 | 180 | 180 | 180 | 180 |
| step | Energization time | 150 | 150 | 150 | 150 | 150 |
| | (second) | | | | | |
| Evaluation | Solt spray test | | | | | |
| | Blister evaluation | X | X | Δ | X | X |
| | Peeling test | X | X | Δ | X | X |
| | Salt water immersion test | | | | | |
| | Blister evaluation | X | X | Δ | X | X |
| | Peeling test | X | X | Δ | X | X |

| | | | | | |
|---|---|---|---|---|---|
| Amount of electrolytic reaction product | 2 | 3 | 0.5 | 5 | 5 |
| deposited (mg/m²) | | | | | |
| Conductivity (μS/cm) | 2400 | 2600 | 1800 | 2900 | 3000 |
| pH | 6.2 | 6.1 | 6.3 | 6.0 | 5.9 |

¹⁾Copper double salt: [Cu(OH)2]x[CuSiO3]y[CuSO4]z[H2O]n weight ratio x/y/z = 50/3/35
²⁾The amount of each component is % by weight in terms of metal.

As apparent from Tables 1 to 4, it was confirmed that the multi-layer coating films obtained by the present invention had excellent corrosion resistance. On the other hand, it was confirmed that the coating films obtained by Comparative Examples had poor corrosion resistance.

### INDUSTRIAL APPLICABILITY

According to the method for forming a multi-layer coating film of the present invention, a cathode electrolytic treatment step (pre-treating step) and an electrodeposition coating step can be practically divided and continuously carried out by using one aqueous coating composition and applying voltage to it in at least two stages. The method of the present invention can efficiently combine the pre-treating step and the electrodeposition coating, and can give multi-layer coating films with high adhesion property to coating films and corrosion resistance. The method of the present invention can considerably shorten the conventional pre-treating such as chemical treatment and electrodeposition coating step. According to the present invention, the pre-treating and the electrodeposition coating can be conducted by using one aqueous coating composition, whereby the present invention method can omit at least a washing step after the pre-treating step. Moreover, the method of the present invention is useful for environment issues derived from waste liquid treatment, and the like.

1. A method for forming a multi-layer coating film comprising:
dipping a material to be coated in an aqueous coating composition comprising (A) a rare earth metal compound, (B) a base resin having a cationic group, and (C) a curing agent, wherein a content of the rare earth metal compound (A) in the aqueous coating composition is 0.05 to 10% by weight in terms of rare earth metal, based on the solid content of the coating composition;
a pre-treatment which comprises applying a voltage of less than 50 V in the aqueous coating composition, wherein the material to be coated is used as a cathode; and
an electrodeposition coating of applying a voltage of 50 to 450 V in the aqueous coating composition, wherein the material to be coated is used as a cathode.

2. The method for forming a multi-layer coating film of claim 1, wherein aqueous coating composition further comprises (D) a copper compound or (E) a zinc compound.

3. The method for forming a multi-layer coating film of claim 1, wherein, in the pre-treatment, an electrolytic reaction product derived from the rare earth metal compound (A) is present in an amount of not less than 5 mg/m².

4. The method for forming a multi-layer coating film of claim 2, wherein, in the pre-treatment, an electrolytic reaction products derived from the rare earth metal compound (A) and the copper compound (D), or an electrolytic reaction products derived from the rare earth metal compound (A) and the zinc compound (E) is present in an amount of not less than 5 mg/m².

5. The method for forming a multi-layer coating film of claim 1, wherein, in the pre-treating step, an energizing time is 10 to 300 seconds.

6. The method for forming a multi-layer coating film of claim 1, wherein, in the electrodeposition coating step, an energizing time is 30 to 300 seconds.

7. The method for forming a multi-layer coating film of claim 1, wherein the aqueous coating composition has a pH of 5 to 7, and a conductivity of 1500 to 4000 μS/cm.

8. The method for forming a multi-layer coating film of claim 1, wherein the rare earth metal compound (A) is a compound comprising at least one rare earth metal selected from the group consisting of cerium (Ce), yttrium (Y), neodymium (Nd), praseodymium (Pr) and ytterbium (Yb).

9. A multi-layer coating film obtained by a method for forming a multi-layer coating film of which comprises:
dipping a material to be coated in an aqueous coating composition comprising (A) a rare earth metal compound, (B) a base resin having a cationic group, and (C) a curing agent, wherein a content of the rare earth metal compound (A) in the aqueous coating composition is 0.05 to 10% by weight in terms of rare earth metal, based on the solid content of the coating composition;
a pre-treatment which comprises applying a voltage of less than 50 V in the aqueous coating compositions wherein the material to be coated is used as a cathode; and
an electrodeposition coating of applying a voltage of 50 to 450 V in the aqueous coating composition, wherein the material to be coated is used as a cathode.
